(19) United States
(12) Patent Application Publication
(10) Pub. No.: US 2026/0177680 A1
(43) Pub. Date: Jun. 25, 2026

(54) LIDAR DEVICE AND OPERATING METHOD THEREOF

(71) Applicant: SAMSUNG ELECTRONICS CO., LTD., Suwon-si (KR)

(72) Inventors: Sangyun PARK, Suwon-si (KR); Byunghoon KO, Suwon-si (KR); Jangwoo YOU, Suwon-si (KR); Jinwoo CHOI, Suwon-si (KR)

(73) Assignee: SAMSUNG ELECTRONICS CO., LTD., Suwon-si (KR)

(21) Appl. No.: 19/422,724

(22) Filed: Dec. 17, 2025

(30) Foreign Application Priority Data
Dec. 19, 2024 (KR) 10-2024-0191728

(51) Int. Cl. G01S 7/4915; G01S 7/4911; G01S 17/58

(52) U.S. Cl. CPC G01S 7/4915; G01S 7/4911; G01S 17/58

(57) ABSTRACT

A light detection and ranging (LiDAR) device includes a transmitter configured to radiate a transmission signal to a target, an optical element between the transmitter and the target, a receiver, and a circuit. The transmission signal includes a first transmission signal portion and a second transmission signal portion different from the first transmission signal portion. The optical element is configured to modulate the first transmission signal portion with a modulation frequency, and reflect the modulated first transmission signal portion. The receiver is configured to generate a first beat signal by mixing a first reception signal reflected from the target with the transmission signal, and generate a second beat signal by mixing a second reception signal reflected from the optical element with the transmission signal. The circuit is configured to generate a clock signal based on the second beat signal, and correct the first beat signal by using the clock signal.

### CROSS-REFERENCE TO RELATED APPLICATIONS

This application claims priority under 35 U.S.C. § 119 to Korean Patent Application No. 10-2024-0191728, filed on Dec. 19, 2024, in the Korean Intellectual Property Office, the disclosure of which is incorporated by reference herein in its entirety.

### BACKGROUND

### 1. Field

The present disclosure relates generally to light detection and ranging (LiDAR) devices, and more particularly, to a LIDAR device using a frequency-modulated continuous wave (FMCW) driving method and an operating method of the LIDAR device.

### 2. Description of Related Art

Light detection and ranging (LiDAR) devices may be used in various fields that may include, but not be limited to, driverless cars, autonomous vehicles, drones, robots, precision measurement devices, or the like. For example, LiDAR devices may use a frequency-modulated continuous wave (FMCW) driving method. Such LiDAR devices may be used as a sensor configured to obtain in real time four-dimensional (4D) information, which may include distance and/or speed information, with respect to an object in front of the LiDAR device by using a signal having a frequency that may continuously change.

That is, LiDAR devices using the FMCW driving method may radiate a signal having a frequency that changes over time to a target object and may receive a reflected signal from the target object to generate and analyze a beat frequency according to a delay time difference between the signals. In such a manner, the LiDAR devices may measure a speed and/or a distance to the target object.

A measurement accuracy of a FMCW LiDAR device may be affected by a degree of linearity with which a transmission signal output by the LiDAR device increases and/or decreases. For example, when a transmission signal increases in a non-linear manner, a signal (hereinafter, referred to as a reception signal) reflected from a target may also return in a non-linear manner. In such a case, an interference signal (hereinafter, referred to as a beat signal) between the transmission signal and the reception signal may not be constant and may vary according to a frequency difference between the two signals. That is, when the non-linearity of the transmission signal increases, a spectrum peak sharpness of the beat frequency may be lowered, which may lead to a decreased signal-to-noise ratio (SNR) of the FMCW LiDAR device.

Recently, research may have been conducted to attempt to address the linearity of transmission signals. For example, a method for potentially improving an SNR of a LIDAR device may include generating a reference signal through a reference arm having an optical delay of a pre-identified length and using the reference signal.

However, when the aforementioned technology is applied to a high-resolution LiDAR device including a multi-wavelength light source, the system complexity may increase to secure the linearity of a transmission signal, and accordingly, system efficiency may be degraded. In addition, the increased complexity of such devices may also result in increased manufacturing and/or operational costs, which may reduce the feasibility of applying the foregoing technology to an actual system.

### SUMMARY

One or more example embodiments of the present disclosure a high-resolution light detection and ranging (LiDAR) device that has an improved signal-to-noise ratio (SNR) without increasing a complexity of a system, when compared to related LiDAR devices.

The technical objects that the present disclosure aims to achieve are not limited to the foregoing, and other technical objects may be inferred from the following embodiments.

According to an aspect of the present disclosure, a light detection and ranging (LiDAR) device includes a transmitter configured to radiate a transmission signal to a target, an optical element between the transmitter and the target, a receiver, and a circuit coupled with the transmitter and the receiver. The transmission signal includes a first transmission signal portion and a second transmission signal portion different from the first transmission signal portion. The optical element is configured to modulate the first transmission signal portion with a modulation frequency, and reflect the modulated first transmission signal portion. The receiver is configured to generate a first beat signal by mixing a first reception signal reflected from the target with the transmission signal, and generate a second beat signal by mixing a second reception signal reflected from the optical element with the transmission signal. The circuit is configured to generate a clock signal based on the second beat signal, and correct the first beat signal by using the clock signal.

The optical element of the LiDAR device may include a modulator and a reflector. The modulator may be configured to modulate the first transmission signal portion with the modulation frequency, pass the modulated first transmission signal portion, and pass the second transmission signal portion without modulation. The reflector may be configured to reflect the modulated first transmission signal portion to the modulator.

The modulator of the optical element may be further configured to modulate the modulated first transmission signal portion reflected from the reflector resulting in the second reception signal. A frequency shift of the second reception signal may be equal to two times the modulation frequency.

The modulator of the optical element may include an acousto-optical modulator (AOM).

The transmitter and the receiver of the LiDAR device may be disposed as a plurality of pixels on a focal plane. The LiDAR device may further include a lens configured to control a light output angle of light emitted from the plurality of pixels to a free space. The optical element of the LiDAR device may be between the focal plane and the lens.

The transmitter and the receiver of the LiDAR device may be disposed as a plurality of pixels on a focal plane. The optical element of the LiDAR device may be disposed in an area of the focal plane.

The transmitter and the receiver of the LiDAR device may be disposed as a plurality of pixels on a focal plane. The LiDAR device may further include a lens configured to control a light output angle of light emitted from the plurality of pixels to a free space. The lens of the LiDAR device may be between the focal plane and the optical element.

The circuit of the LiDAR device may be further configured to extract, by using a filter, the second beat signal from a measurement result of at least one photodetector, and generate the clock signal based on the extracted second beat signal.

The circuit of the LiDAR device may be further configured to convert a measurement result of at least one photodetector into a digital signal, extract, by using a software-based filter, the first beat signal and the second beat signal from the digital signal, and correct the first beat signal based on the extracted second beat signal.

The circuit of the LiDAR device may be further configured to calculate, based on the corrected first beat signal, at least one of a speed of the target or a distance to the target.

The optical element of the LiDAR device may be further configured to modulate a frequency of the first transmission signal portion based on time.

According to an aspect of the present disclosure, an operating method of a LiDAR device includes irradiating, by using a transmitter of the LiDAR device, a transmission signal to a target, generating a first beat signal by mixing a first reception signal reflected from the target with the transmission signal, modulating, by using an optical element of the LiDAR device, the first transmission signal portion with a modulation frequency, resulting in a second reception signal, generating a second beat signal by mixing the second reception signal with the transmission signal, generating a clock signal based on the second beat signal, and correcting the first beat signal by using the clock signal. The transmission signal includes a first transmission signal portion and a second transmission signal portion different from the first transmission signal portion. The optical element is between the transmitter and the target.

The generating of the second beat signal may include passing, by using the optical element, at a modulated frequency the first transmission signal portion by modulating, by using a modulator of the optical element, the first transmission signal portion with the modulation frequency, passing, by using the optical element, the second transmission signal portion without modulation, and reflecting, by using a reflector of the optical element, the modulated first transmission signal portion to the modulator.

The operating method of the LiDAR device may further include modulating the modulated first transmission signal portion reflected from the reflector resulting in the second reception signal. A frequency shift of the second reception signal may be equal to two times the modulation frequency.

The generating of the clock signal may include extracting, by using a filter, the second beat signal from a measurement result of at least one photodetector, and generating the clock signal based on the extracted second beat signal.

The generating of the clock signal may include generating the clock signal by thresholding the extracted second beat signal and then multiplying a frequency of the thresholded second beat signal.

The generating of the clock signal may include generating the clock signal by multiplying a frequency of the extracted second beat signal and then thresholding the frequency-multiplied second beat signal.

The correcting of the first beat signal may include removing, by using the clock signal, at least one distortion in a measurement result of at least one photodetector.

The correcting of the first beat signal may include extracting, by using a filter, the first beat signal from a measurement result of at least one photodetector, and correcting, by using the clock signal, the first beat signal by removing a distortion in the extracted first beat signal.

The operating method of the LiDAR device may further include calculating, based on the corrected first beat signal, at least one of a speed of the target or a distance to the target.

Additional aspects are set forth in part in the description that follows and, in part, may be apparent from the description, or may be learned by practice of the presented embodiments of the disclosure.

### BRIEF DESCRIPTION OF THE DRAWINGS

The above and other aspects, features, and advantages of certain embodiments of the disclosure may be more apparent from the following description taken in conjunction with the accompanying drawings, in which:

FIG. 1 is a diagram illustrating a transmission signal and a reception signal, which have a frequency increasing and/or decreasing in a linear manner, and a beat signal according to the transmission signal and the reception signal, according to an embodiment;

FIG. 2 is a diagram illustrating a transmission signal and a reception signal, which have a frequency increasing and/or decreasing in an non-linear manner, according to an embodiment;

FIG. 3 is a graph showing characteristics of a beat signal generated from the transmission signal and the reception signal of FIG. 2, according to an embodiment;

FIG. 4 is a diagram illustrating a light detection and ranging (LiDAR) device, according to an embodiment;

FIG. 5 depicts graphs of a first reception signal and a second reception signal that are received by the LiDAR device of FIG. 4, and a first beat signal and a second beat signal according to the first and second reception signals, according to an embodiment;

FIG. 6 is a diagram illustrating a method of correcting a first beat signal by using a clock signal, according to an embodiment;

FIG. 7 depicts graphs of a method of generating a clock signal and a method of correcting a first beat signal, according to an embodiment;

FIG. 8 is a diagram illustrating an optical element, according to an embodiment;

FIG. 9 depicts graphs of a second beat signal according to a frequency shift of a second reception signal, according to an embodiment;

FIG. 10 is a flowchart illustrating a method of correcting a first beat signal by a LiDAR device, according to an embodiment;

FIG. 11 depicts graphs showing characteristics of a first beat signal before and after correction, according to an embodiment;

FIG. 12 is a conceptual diagram illustrating a LIDAR device, according to an embodiment;

FIG. 13 is a diagram illustrating a pixel included in a focal plane array, according to an embodiment;

FIG. 14 is a block diagram illustrating a circuit, according to an embodiment;

FIG. 15 is a diagram illustrating an arrangement relation of an optical element, according to an embodiment;

FIG. 16 is a diagram illustrating an arrangement relation of an optical element, according to an embodiment;

FIG. 17 is a diagram illustrating an arrangement relation of an optical element, according to an embodiment;

FIG. 18 is a block diagram illustrating a schematic configuration of an electronic device including a LIDAR device, according to an embodiment; and

FIG. 19 is a diagram illustrating an example in which a LIDAR device is applied to a vehicle, according to an embodiment.

### DETAILED DESCRIPTION

Reference is now made to embodiments of the present disclosure, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” may include any and all combinations of one or more of the associated listed items. Expressions such as “at least one of,” when preceding a list of elements, modify the entire list of elements and do not modify the individual elements of the list.

General terms that are currently used widely have been selected for use in consideration of their functions in embodiments. However, such terms may be changed according to an intention of a person skilled in the art, precedents, advent of new technologies, or the like. Further, in certain cases, terms may have been arbitrarily selected, and in such cases, meanings of the terms may be described in the corresponding descriptions. Accordingly, the terms used in the embodiments should be defined based on their meanings and overall descriptions of the embodiments, not simply by their names.

In some descriptions of the embodiments, when a portion is described as being connected to another portion, the portion may be connected directly to another portion, or electrically connected to another portion with an interposing portion therebetween. An expression used in the singular encompasses the expression of the plural, unless it has a clearly different meaning in the context. When a portion “includes” a component, another component may be further included, rather than excluding the existence of the other component, unless otherwise described.

The terms “comprise” or “include” used in the embodiments should not be construed as including all components or operations described in the present disclosure, and may be understood as not including some of the components or operations, or further including additional components or operations.

While such terms as “first,” “second,” or the like, may be used to describe various components, such components must not be limited to the above terms. The above terms are used only to distinguish one component from another, and do not limit the components in other aspect (e.g., importance or order). For example, the terms “first”, “second”, “third”, or the like may not necessarily involve an order or a numerical meaning of any form.

As used herein, when an element or layer is referred to as “covering”, “overlapping”, or “surrounding” another element or layer, the element or layer may cover at least a portion of the other element or layer, where the portion may include a fraction of the other element or may include an entirety of the other element.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment. The embodiments described herein are example embodiments, and thus, the disclosure is not limited thereto and may be realized in various other forms.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

The embodiments herein may be described and illustrated in terms of blocks, as shown in the drawings, which carry out a described function or functions. These blocks, which may be referred to herein as units or modules or the like, or by names such as device, logic, circuit, controller, counter, comparator, generator, converter, or the like, may be physically implemented by analog and/or digital circuits including one or more of a logic gate, an integrated circuit, a microprocessor, a microcontroller, a memory circuit, a passive electronic component, an active electronic component, an optical component, and the like.

In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

The descriptions of the following embodiments should not be construed as limiting the scope of rights, and matters that those of ordinary skill in the art may easily derive should be construed as being included in the scope of rights of the embodiments.

Hereinafter, various embodiments of the present disclosure are described with reference to the accompanying drawings.

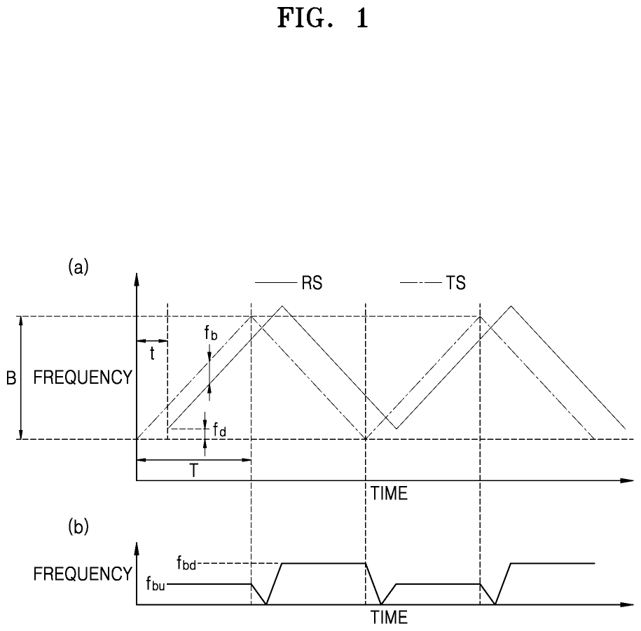

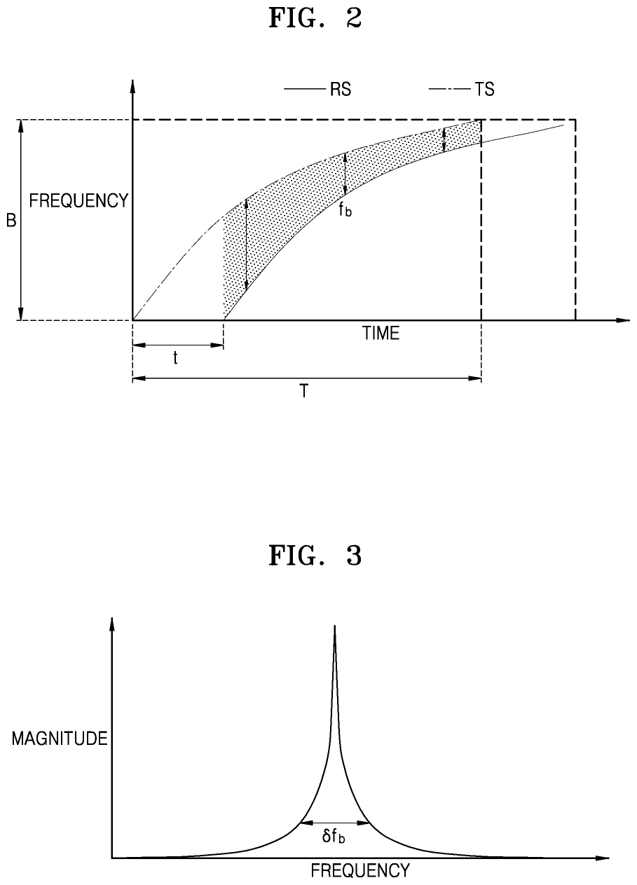

FIG. 1 is a diagram illustrating a transmission signal TS and a reception signal RS, which have a frequency increasing and/or decreasing in a linear manner and a beat signal (e.g., ƒ_{bu} and ƒ_{bd}), according to the transmission signal TS and the reception signal RS, according to an embodiment. FIG. 2 is a diagram illustrating a transmission signal TS and a reception signal RS, which have a frequency increasing and/or decreasing in a non-linear manner, according to an embodiment. FIG. 3 is a graph showing characteristics of a beat signal fb generated from the transmission signal TS and the reception signal RS of FIG. 2, according to an embodiment.

Referring to FIGS. 1 to 3, the transmission signal TS used in a light detection and ranging (LiDAR) device using a frequency-modulated continuous wave (FMCW) driving method may be a continuous wave having a modulated frequency. For example, a frequency of the transmission signal TS may change in a linear or non-linear manner according to time.

The graph (a) of FIG. 1 shows the transmission signal TS and the reception signal RS that have a frequency increasing and/or decreasing in a linear manner. The transmission signal TS is illustrated by using an alternate long and short dash line, and the reception signal RS is illustrated by using a solid line. Referring to graph (a) of FIG. 1, B may represent a modulation bandwidth and T may represent a modulation period. As used herein, the modulation bandwidth B may refer to a range of varying frequency of the transmission signal TS and may indicate a difference between a maximum frequency and a minimum frequency of the transmission signal TS. As used herein, the modulation period T may refer to a time period taken for complete modulation of frequency of the transmission signal TS and may indicate a time period consumed for completion of frequency sweep (e.g., up-chirp or down-chirp) of the transmission signal TS.

When the frequency of the transmission signal TS radiated towards the target from the LiDAR device increases and/or decreases linearly, the frequency of the reception signal RS which is reflected from the target and returns to the LiDAR device may also increase and/or decrease linearly.

As shown in graph (a), there may be a delay time t between a transmission time of the transmission signal TS from the LiDAR device and a detection time of the reception signal RS by the LiDAR device. Accordingly, a constant frequency difference ƒ_{b} may be formed between the transmission signal TS and the reception signal RS. In addition, due to a change in a speed and a relative distance between the LiDAR device and the target, a frequency change which corresponds to a Doppler frequency ƒ_{d} of the transmission signal TS and the reception signal RS may be caused.

Accordingly, the beat signal ƒ_{b} generated due to interference between the transmission signal TS and the reception signal RS may have a constant frequency. As used herein, the beat signal may refer to a signal generated by mixing the transmission signal TS with the reception signal RS and may indicate a signal having a beat frequency. For example, the beat signal may refer to a signal generated by mixing the transmission signal TS and the reception signal RS, and the beat frequency may refer to a frequency of the beat signal. The beat frequency may correspond to a frequency difference between the transmission signal TS and the reception signal RS.

The graph (b) of FIG. 1 shows an upbeat signal ƒ_{bu} and a downbeat signal ƒ_{bd} generated from the transmission signal TS and the reception signal RS of graph (a). The upbeat signal ƒ_{bu} shows a beat frequency corresponding to the up-chirp, the downbeat signal ƒ_{bd} shows a beat frequency of the down-chirp, which may be represented as respective equations similar to Equations 1 and 2.

$${f}_{bu} = {f}_{b} - {f}_{d} \qquad [ Equation 1 ]$$

$${f}_{bd} = {f}_{b} + {f}_{d} \qquad [ Equation 2 ]$$

In addition, the Doppler frequency ƒ_{d} may be proportional to a relative speed ν of the target with respect to the LiDAR device and may be inversely proportional to a wavelength λ of the transmission signal TS, which may be represented as an equation similar to Equation 3.

$${f}_{d} = \frac{2 v}{λ} \qquad [ Equation 3 ]$$

Accordingly, a distance R between the LiDAR device and the target may be proportional to an average of the downbeat signal ƒ_{bd} and the upbeat signal ƒ_{bu} and may be represented as an equation similar to Equation 4. A difference between the upbeat signal ƒ_{bu} and the downbeat signal ƒ_{bd} may be proportional to the relative speed ν between the target and the LiDAR device, and may be represented as an equation similar to Equation 5. Referring to Equation 4, slope Equation 4 may represent a speed of frequency modulation.

$$R = \frac{c}{4 \times slope} ( {f}_{bd} + {f}_{bu} ) \qquad [ Equation 4 ]$$

$$v = \frac{λ}{4} ( {f}_{bd} - {f}_{bu} ) \qquad [ Equation 5 ]$$

Referring to FIG. 2, the transmission signal TS and the reception signal RS, which have a frequency increasing and/or decreasing in a non-linear manner, are illustrated using an alternate long and short dash line and a solid line, respectively. Unlike the example of FIG. 1, physical limitations of a LIDAR device, such as, but not limited to, temperature change, noise, or the like, may limit the ability of the LiDAR device to generate a transmission signal TS that may be substantially and/or perfectly linear.

When the frequency of the transmission signal TS radiated towards the target from the LiDAR device increases and/or decreases non-linearly, the frequency of the reception signal RS, which is reflected from the target and returns to the LiDAR device, may also increase and/or decrease non-linearly. Accordingly, the beat signal ƒ_{b} generated due to interference between the transmission signal TS and the reception signal RS may have a fluctuating irregular value.

Referring to FIG. 3, as the non-linearity of the transmission signal TS increases, a frequency bandwidth δƒ_{b} of the beat signal ƒ_{b} may widen (increase). That is, when the non-linearity of the transmission signal TS increases, a quality factor of the LiDAR device may decrease.

Since increased non-linearity of the transmission signal TS may lead to a widened spectrum peak width of the beat signal ƒ_{b}, it may be difficult for the LiDAR device to precisely and/or accurately measure and/or extract the beat signal ƒ_{b}. Consequently, the non-linearity of the transmission signal TS may diminish a signal-to-noise ratio (SNR) of the LiDAR device and, by extension, the performance of the LIDAR device. For example, when the frequency of the transmission signal TS varies in a non-linear manner according to time, the measurement accuracy of the speed and/or distance of the LiDAR device may be lowered. Alternatively or additionally, when the frequency of the transmission signal TS varies in a non-linear manner according to time, a maximum measurable distance of the LiDAR device may be reduced.

Hereinafter, a configuration of the LiDAR device that may improve the performance thereof, when compared to related LiDAR devices, even when the transmission signal TS has a frequency increasing and/or decreasing in a non-linear manner and an operating method of the LiDAR device are described.

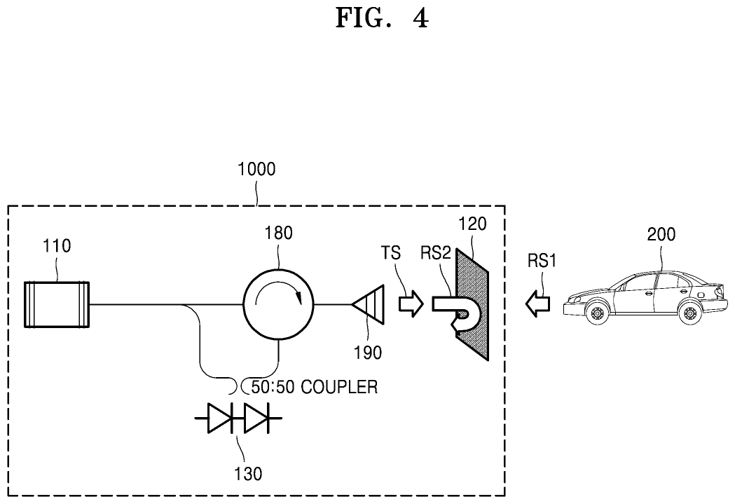

FIG. 4 is a diagram illustrating a LIDAR device 1000, according to an embodiment. Referring to FIG. 4, the LiDAR device 1000 may radiate and/or release the transmission signal TS towards a target 200 and may receive and/or detect a first reception signal RS1 reflected from the target 200 and a second reception signal RS2 reflected from an optical element 120.

The LiDAR device 1000 may radiate the transmission signal TS to the target 200 through a transmitter. The transmitter may radiate the transmission signal TS having a frequency-modulated continuous wave to the target 200. For example, the transmitter may include a laser 110, a modulator, and an optical antenna 190. The optical antenna 190 may be implemented by at least one of a grating coupler, an edge coupler, an integrated reflector, or a spot size converter. However, embodiments of the present disclosure are not limited in this regard.

The laser 110 may generate laser light of a certain wavelength. For example, the laser 110 may include a solid-state laser. However, embodiments of the present disclosure are not limited thereto. For example, the laser 110 may include a laser diode, a fiber laser, a vertical-cavity surface-emitting laser, or the like.

The modulator may modulate the transmission signal TS generated by the laser 110. For example, the modulator may modulate the transmission signal TS such that the frequency thereof changes according to time. Accordingly, the frequency of the transmission signal TS may be changed in a continuous form that may increase and/or decrease according to time. The transmission signal TS may be radiate through the optical antenna 190 to the target 200 of which distance and/or speed may need to be measured.

The components of the transmitter may not be limited to the above, and some of the components may be removed, or other components may be added according to an embodiment. The components of the transmitter may be distinguished and listed for the sake of convenient description, and the components do not necessarily have to be divided hardware-wise. In addition, according to an embodiment, the components of the transmitter may be included in another device and may not need to be hardware components included in the LiDAR device 1000.

The LiDAR device 1000 may include the optical element 120 arranged between the transmitter and the target 200 and may be configured to partially reflect the transmission signal TS.

The optical element 120 may include a partial reflector configured to reflect a part of the signal and pass the rest of the signal. For example, the partial reflector may include, but not be limited to, glass or plastic that may be partially coated for reflection. However, embodiments of the present disclosure are not limited thereto. For example, the partial reflector may be, for example, a dichroic mirror, a gas cell reflector, or the like.

The optical element 120 may be arranged in a free space of the LiDAR device 1000. For example, the optical element 120 may be arranged in the free space of the LiDAR device 1000 and may be configured to pass a part of the transmission signal TS towards the target 200 and reflect the rest of the transmission signal TS towards the receiver.

That is, the part of the transmission signal TS that has been radiate towards the target 200 may be reflected from the target 200 after passing through the optical element 120 to form the first reception signal RS1, and the rest of transmission signal TS may be reflected from the optical element 120 to form the second reception signal RS2.

The receiver of the LiDAR device 1000 may include at least one optical interferometer and at least one photodetector 130. The receiver may generate a first beat signal ƒ₁ and a second beat signal ƒ₂ based on the first reception signal RS1, the second reception signal RS2, and the transmission signal TS by using the at least one optical interferometer and/or the at least one photodetector 130. The photodetector 130 may include a balanced photodetector (BPD) including a pair of two photodetectors. However, embodiments of the present disclosure are not limited thereto, and the photodetector 130 may include other types of photodetectors without departing from the scope of the disclosure.

The receiver may generate a first optical signal by mixing the first reception signal RS1 and the transmission signal TS and may generate a second optical signal by mixing the second reception signal RS2 and the transmission signal TS. By using the photodetector 130, the receiver may convert the first optical signal and the second optical signal into the first beat signal ƒ₁ and the second beat signal ƒ₂, respectively, which may be electric signals.

The number of the optical interferometers comprised by the receiver is not limited to the foregoing. For example, the receiver may include one optical interferometer and one balanced photodetector 130 including a pair of two photodetectors.

By using the photodetector 130, the receiver may detect the first beat signal ƒ₁ based on the interference between the first reception signal RS1 and the transmission signal TS. Alternatively or additionally, the receiver may detect the second beat signal ƒ₂ based on the interference between the second reception signal RS2 and the transmission signal TS.

For example, the receiver may generate the first optical signal by mixing the first reception signal RS1 and the transmission signal TS and may generate the second optical signal by mixing the second reception signal RS2 and the transmission signal TS. The photodetector 130 may convert the first optical signal and the second optical signal into the first beat signal ƒ₁ and the second beat signal ƒ₂, respectively, which may be electric signals. The optical interferometer may receive a local oscillator signal (LOS) in one direction and receive the first reception signal RS1 and the second reception signal RS2 in the opposite direction of the foregoing direction. As used herein, the local oscillator signal may refer to a signal generated by the laser 110 and received in one direction of the optical interferometer. The optical interferometer may receive the transmission signal TS in one direction and may receive the first reception signal RS1 and the second reception signal RS2 in the opposite direction of the foregoing direction.

There may be interference between the transmission signal TS and each of the first reception signal RS1 and the second reception signal RS2. For example, there may be interference between the transmission signal TS and each of the first reception signal RS1 and the second reception signal RS2, and accordingly, the optical interferometer may generate the first optical signal and the second optical signal that may result from the interference.

As the interference may be caused between the transmission signal TS and each of the first reception signal RS1 and the second reception signal RS2, the optical interferometer may generate the first optical signal and the second optical signal. For example, the first beat signal ƒ₁ may be generated by the interference between the transmission signal TS and the first reception signal RS1, and the second beat signal ƒ₂ may be generated by the interference between the transmission signal TS and the second reception signal RS2. Accordingly, each of the first optical signal and the second optical signal may include the first beat signal ƒ₁ and the second beat signal ƒ₂.

Each of the first beat signal ƒ₁ and the second beat signal ƒ₂ included in the first optical signal may have the same intensity as the first beat signal ƒ₁ and the second beat signal ƒ₂ included in the second optical signal and may have a phase opposite to the phase of the first beat signal ƒ₁ and the phase of second beat signal ƒ₂ of the second optical signal. Accordingly, the photodetector 130 may detect the first beat signal ƒ₁ and the second beat signal ƒ₂ by differentiating between the first optical signal and the second optical signal.

The component for coupling the first optical signal and the second optical signal by the receiver may not limited to the optical antenna 190. For example, the receiver may generate the first optical signal and the second optical signal by using a beam splitter, and the balanced photodetector 130 may detect the first beat signal ƒ₁ and the second beat signal ƒ₂ by differentiating between the first optical signal and the second optical signal.

In addition, the components of the receiver may not be limited to the above, and some of the components may be removed, or other components may be added according to an embodiment. The components of the receiver may be distinguished for the sake of convenient description, and the components may not necessarily have to be divided hardware-wise. In addition, according to an embodiment, the components of the receiver may be included in another device and may not need to be hardware components included in the LiDAR device 1000.

The LiDAR device 1000, according to an embodiment, may further include a circulator 180. The circulator 180 may be arranged on an optical path of the LIDAR device and may divide the transmission signal TS from the reception signal RS to avoid mutual interference. For example, when the transmission signal TS has arrived at the target 200 through a path, with the help of the circulator 180, the first reception signal RS1 and the second reception signal RS2, which are reflected from the target 200 or the optical element 120, may be received through different paths from each other.

The component for dividing travel paths of the transmission signal TS, the first reception signal RS1, and the second reception signal RS2 is not limited to the circulator 180, and the LiDAR device 1000 may divide the travel paths of the signals by using a beam splitter.

Although FIG. 4 illustrates that the optical element 120 is being arranged in the free space of the LiDAR device 1000, the position of the optical element 120 is not limited thereto.

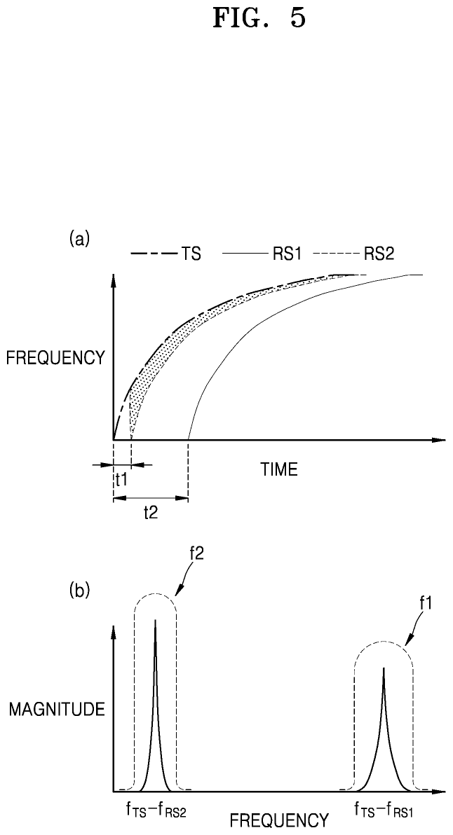

FIG. 5 depicts graphs of a first reception signal RS1 and the second reception signal RS2 that are received by the LiDAR device 1000 of FIG. 4, and the first beat signal ƒ₁ and the second beat signal ƒ₂ according to the first and second reception signals, according to an embodiment.

Referring to graph (a) of FIG. 5, the transmission signal TS, the first reception signal RS1, and the second reception signal RS2, which each have a frequency increasing and/or decreasing non-linearly, are illustrated using an alternate long and short dash line, a solid line, and a dotted line, respectively. The graph (b) of FIG. 3 illustrates the first beat signal ƒ₁, generated from the first reception signal RS1 and the transmission signal TS, and the second beat signal ƒ₂, generated from the second reception signal RS2 and the transmission signal TS.

Referring to graph (a) of FIG. 5, the first reception signal RS1 may be received by the receiver after a lapse of a first delay time t₁ from a transmission time point of the transmission signal TS from the transmitter, and the second reception signal RS2 may be received by the receiver after a lapse of a second delay time t₂ from the transmission time point of the transmission signal TS from the transmitter.

The receiver may generate the first optical signal and the second optical signal based on the first delay time t₁, the second delay time t₂, and the Doppler effect between the LiDAR device 1000 and the target 200.

For example, the receiver may generate the first optical signal based on the first delay time ty and the Doppler effect between the first reception signal RS1 and the transmission signal TS. As another example, the receiver may generate the second optical signal based on the second delay time t₂ and the Doppler effect between the second reception signal RS2 and the transmission signal TS.

Referring to graph (b) of FIG. 5, with respect to the same frequency domain, the first beat signal ƒ₁ may detected in a relatively low frequency domain, and the second beat signal ƒ₂ may be detected in a relatively high frequency domain.

The receiver may detect the first beat signal ƒ₁ and the second beat signal ƒ₂ by using at least one photodetector 130.

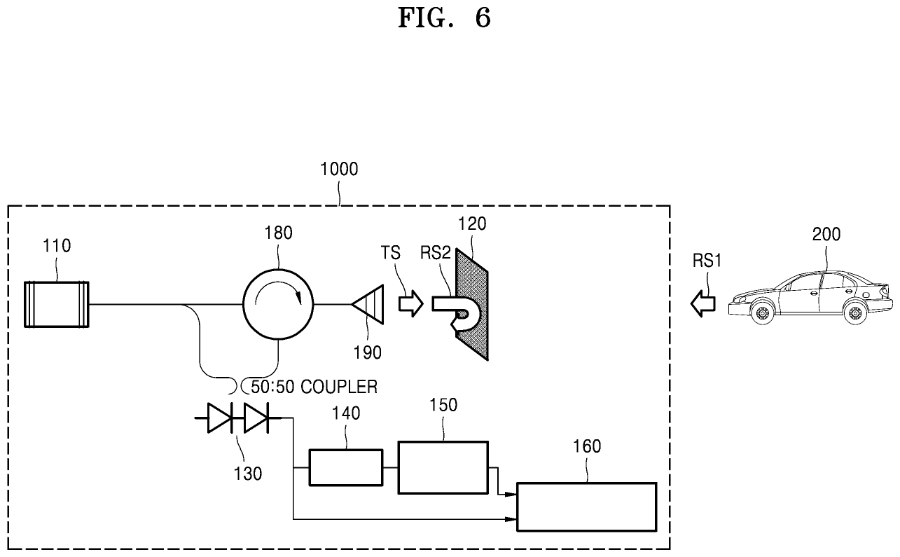

A method of correcting the first beat signal ƒ₁ by the LiDAR device 1000, by using the second beat signal ƒ₂, is described with reference to FIG. 6.

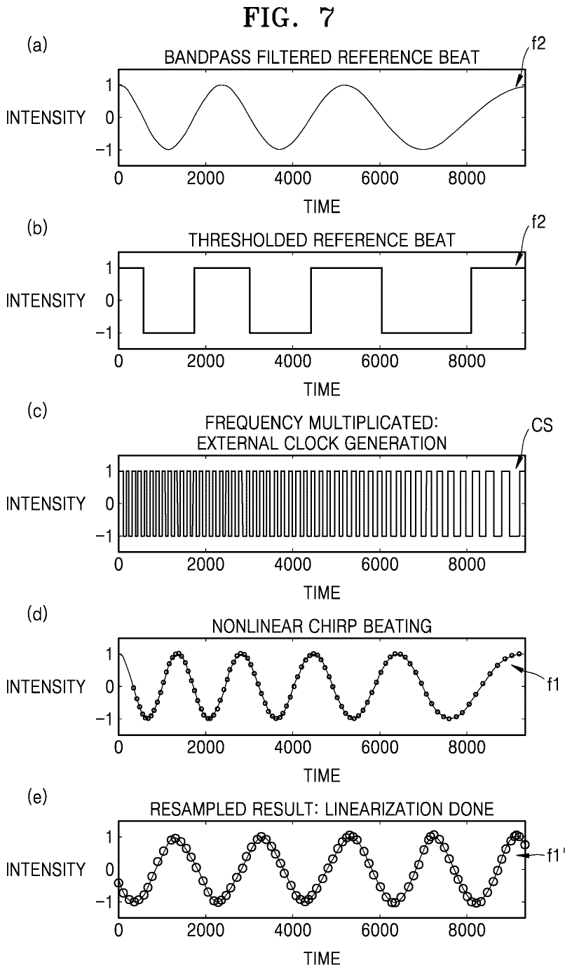

FIG. 6 is a diagram for illustrating a method of correcting the first beat signal ƒ₁ by the LiDAR device 1000 by generating a clock signal CS, according to an embodiment. FIG. 7 depicts graphs of the method of correcting the first beat signal ƒ₁ by generating the clock signal CS, according to an embodiment.

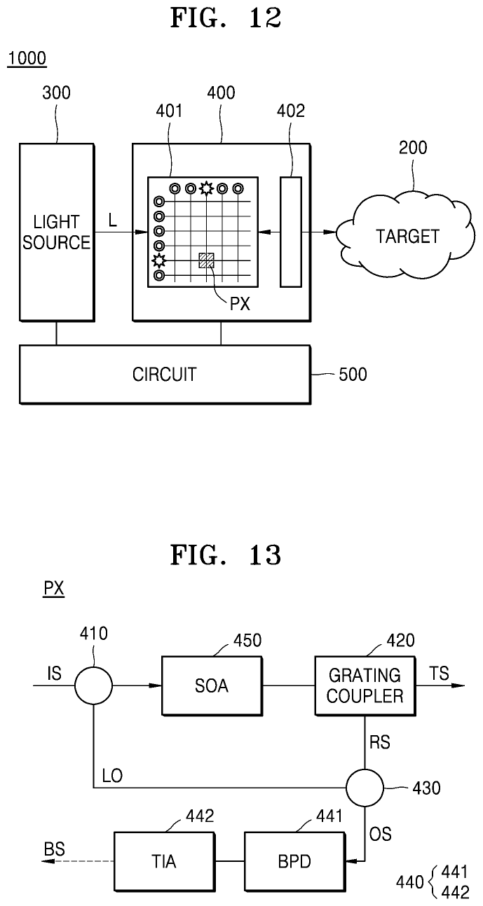

Referring to FIG. 6, the LiDAR device 1000 may further include a filter 140, a clock signal generator 150, and an analog/digital (AD) converter 160. At least one of the filter 140, the clock signal generator 150, or the AD converter 160 may be included in a circuit 500 described with reference to FIG. 12. Referring to FIG. 7, the graph (a) shows the second beat signal ƒ₂ extracted by the filter 140, the graph (c) shows the clock signal CS generated by the clock signal generator 150, and the graph (e) shows a first beat signal ƒ₁′ corrected by the AD converter 160.

The filter 140 may isolate the first beat signal ƒ₁ and the second beat signal ƒ₂ that may be detected in the same frequency domain by frequency band. For example, the filter 140 may include, but limited to, a band pass filter, a low pass filter, a high pass filter, or a combination thereof and may extract the first beat signal ƒ₁ and/or the second beat signal ƒ₂ from the measurement result of the at least one photodetector 130.

The clock signal generator 150 may generate the clock signal CS by using the second beat signal ƒ₂ extracted by the filter 140. The clock signal generator 150 may include a component for thresholding the second beat signal ƒ₂ and a component for multiplying a frequency of the second beat signal ƒ₂.

The clock signal generator 150 may generate the clock signal CS by thresholding the second beat signal ƒ₂ and then multiplying the frequency thereof. The clock signal generator 150 may convert a waveform of the second beat signal ƒ₂ from a sine waveform to a discrete pulse waveform and then generate the clock signal CS by multiplying the frequency of the second beat signal ƒ₂.

For example, the clock signal generator 150 may sample and quantize the second beat signal ƒ₂ having a sine waveform, as illustrated in the graph (a) of FIG. 7, to generate pulse waveform having a second beat frequency, as illustrated in the graph (b) of FIG. 7. The clock signal generator 150 may generate the clock signal CS by amplifying the frequency of the second beat signal ƒ₂, as illustrated in the graph (c) of FIG. 7.

The clock signal generator 150, according to an embodiment, may generate the clock signal CS by multiplying the frequency of the second beat signal ƒ₂ and thresholding the second beat signal ƒ₂. That is, the clock signal generator 150 may amplify the frequency of the second beat signal ƒ₂ first and then convert the waveform of the second beat signal ƒ₂ having an amplified frequency from a sine waveform into a pulse waveform. For example, the clock signal generator 150 may convert the waveform of the second beat signal ƒ₂ from a sine waveform into a pulse waveform by sampling and quantizing the second beat signal ƒ₂ having a multiplied frequency. In this manner, the clock signal generator 150 may generate the clock signal CS for correcting the first beat signal ƒ₁.

The AD converter 160 may correct the first beat signal ƒ₁ by using the clock signal CS generated by the clock signal generator 150. For example, the AD converter 160 may be a data acquisition (DAQ) interface. The AD converter 160 may generate the corrected first beat signal ƒ₁′ shown in the graph (e) of FIG. 7 by using the clock signal CS shown in the graph (c) of FIG. 7.

The AD converter 160, according to an embodiment, may generate the corrected first beat signal ƒ₁′ by reducing or removing a distortion of the first beat signal ƒ₁ extracted from the filter 140 by using the clock signal CS generated by the clock signal generator 150.

For example, to potentially avoid a distortion of phase information of the first beat signal ƒ₁, the AD converter 160 may adjust a sampling timing by detecting zero-crossing through matching of the clock signal CS, as shown in the graph (c) of FIG. 7, and the first beat signal ƒ₁, as shown in the graph (d) of FIG. 7. As used herein, the sampling timing may refer to a time point when a signal is read. The AD converter 160 may synchronize the clock signal CS and the first beat signal ƒ₁ by detecting an exact sampling timing of the first beat signal ƒ₁, and accordingly, the corrected first beat signal ƒ₁′, as shown in the graph (e) of FIG. 7, may be generated.

The AD converter 160, according to an embodiment, may correct the first beat signal ƒ₁ by reducing and/or removing a distortion of the measurement result by the at least one photodetector by using the clock signal generated by the clock signal generator 150.

For example, to avoid a distortion of the phase information of the first beat signal ƒ₁, the AD converter 160 may adjust the sampling timing by detecting zero-crossing through matching of the clock signal CS and the first beat signal ƒ₁ and the second beat signal ƒ₂, which may be detected in the same frequency domain. The AD converter 160 may synchronize the clock signal CS and the first beat signal ƒ₁ by detecting an exact sampling timing of the first beat signal ƒ₁, and accordingly, the corrected first beat signal ƒ₁′, as shown in the graph (e) of FIG. 7, may be generated.

In addition, the component of the receiver of the LiDAR device 1000 for correcting the first beat signal ƒ₁ by generating the clock signal CS is not limited to the foregoing examples. In an embodiment, the receiver of the LiDAR device 1000 may correct the first beat signal ƒ₁ by generating the clock signal CS by using only the AD converter 160. In this regard, the AD converter 160 may be a data acquisition interface having a relatively high processing speed.

The AD converter 160 may extract the first beat signal ƒ₁ and the second beat signal ƒ₂ by converting the measurement result of the at least one photodetector into a digital signal and using a software filter. The AD converter 160 may correct the first beat signal ƒ₁ based on the extracted second beat signal ƒ₂.

For example, the AD converter 160 may oversample the measurement result of the at least one photodetector. As used herein, the oversampling may refer to sampling of a signal at a higher sampling speed. That is, the oversampling may refer to obtaining more data by sampling a desired signal more sufficiently and frequently.

The AD converter 160 may extract the first beat signal ƒ₁ and the second beat signal ƒ₂ by applying the software filter to a digital signal obtained at a higher sampling speed though the oversampling. Then, the AD converter 160 may correct the first beat signal ƒ₁ by resampling the first beat signal ƒ₁ to minimize frequency dispersion of the second beat signal ƒ₂.

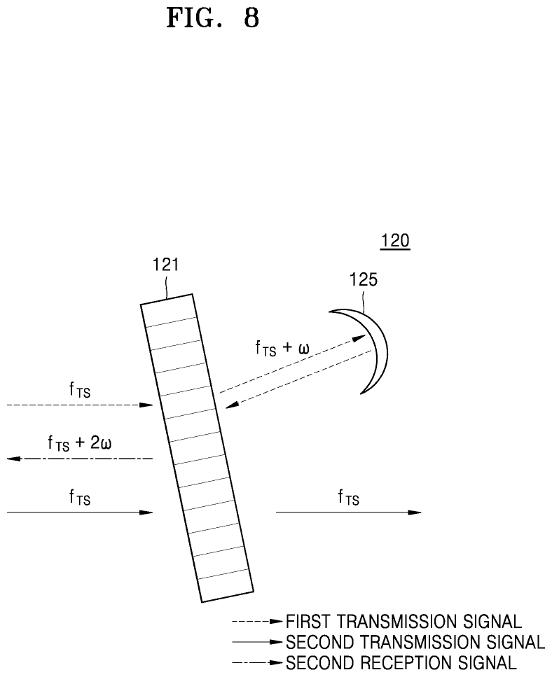

Hereinafter, a method of shifting a center frequency of the second beat signal ƒ₂ is described with reference to FIG. 8. By shifting the center frequency of the second beat signal ƒ₂, effects due to direct current (DC) noise may be reduced. In addition, by shifting the center frequency of the second beat signal ƒ₂, the isolation of the frequencies of the first beat signal ƒ₁ and the second beat signal ƒ₂ by band may be conducted more accurately.

FIG. 8 is a diagram illustrating the optical element, according to an embodiment.

Referring to FIG. 8, the optical element 120, according to an embodiment, may include a modulator 121 and a reflector 125. Through a control signal input to the modulator 121, the optical element 120 may convert a part of the transmission signal into the modulation frequency and reflect the same to the receiver.

The transmission signal may be divided into the first transmission signal and the second transmission signal. The first transmission signal and the second transmission signal may have a central frequency ƒ_{TS}. The modulator 121 may convert the first transmission signal to a frequency obtained by adding a modulation frequency ω to the frequency thereof and pass the first transmission signal at a modulated frequency. The modulator 121 may pass the second transmission signal at the same frequency. The modulator 121 may be and/or may include an optical device configured to control a passing optical frequency into a modulation frequency. The modulator 121 may be and/or may include any one of an acousto-optical modulator (AOM), an electro-optical modulator (EOM), and a thermal optical modulator (TOM). However, embodiments of the present disclosure are not limited thereto.

For example, the modulator 121 may be an acousto-optical modulator, which may also be referred to as a Bragg cell. Due to the Bragg cell effect to external sound waves, in an internal piezoelectric medium of the modulator 121, a travel direction of the first transmission signal (e.g., incident light) may be curved due to first Bragg refraction (e.g., m=1). Accordingly, the incident light frequency ƒ_{TS} may be modulated to ƒ_{TS}+ω due to the first Bragg refraction (e.g., m=1). In addition, the second transmission signal, which may be incident light that may not be refracted, may be output at an unmodulated frequency ƒ_{TS}. The modulator 121 may pass the first transmission signal and the second transmission signal, which may pass through the modulator 121, to different channels from each other. The modulator 121 may control the modulation frequency ω by generating a sound wave for control by using a piezoelectric actuator. However, embodiments of the present disclosure are not limited thereto, and the modulator 121 may control the modulation frequency ω in various other manners without departing from the scope of the present disclosure.

The reflector 125 may reflect the first transmission signal having a modulated frequency such that the first transmission signal is re-incident onto the modulator 121. The first transmission signal re-incident to the modulator 121 may be modulated by +w. Subsequently, the optical element 120 may generate the second reception signal through the frequency shift of the first transmission signal incident to the optical element 120, which may be twice as great (e.g., 2ω) as the modulation frequency. That is, by passing through the modulator 121 twice, the frequency shift caused to the second reception signal reflected from the optical element 120 may be twice as great as the modulation frequency ω. That is, the center frequency of the second reception signal may become ƒ_{TS}+2ω.

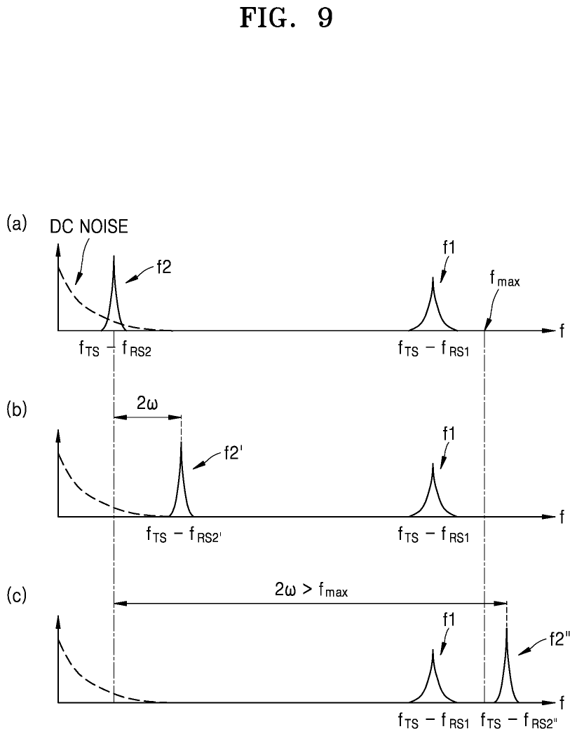

FIG. 9 depicts graphs of the second beat signal according to a frequency shift of the second reception signal, according to an embodiment.

Referring to FIG. 9, the graph (a) illustrates the case in which the modulation frequency of the modulator 121 described with reference to FIG. 8 is zero (0). In the graph (a), the frequency shift of the second reception signal ƒ_{RS2} is zero (0). As the frequency shift of the second reception signal ƒ_{RS2} is zero (0), the center frequency of the second beat signal ƒ₂ generated by mixing the second reception signal ƒ_{RS2} and the transmission signal ƒ_{TS} may be in a relatively low frequency domain, and accordingly, may be affected by DC noise.

The graph (b) illustrates the case in which the modulation frequency of the modulator 121 described with reference to FIG. 8 is 2ω. In the graph (b), the frequency shift of the second reception signal ƒ_{RS2} is 2ω, which is twice as great as the modulation frequency ω. As the frequency shift of the second reception signal ƒ_{RS2} is 2ω, the center frequency of the second beat signal ƒ₂′ generated by mixing the second reception signal ƒ_{RS2} and the transmission signal may be in a relatively high frequency domain, and accordingly, may be free from DC noise. That is, the DC noise area and the second beat signal ƒ₂′ may be isolated from each other in the frequency domain.

The graph (c) illustrates the case in which the modulation frequency of the modulator 121 described with reference to FIG. 8 is greater than ƒₘₐₓ/2. In the graph (c), the frequency shift of the second reception signal ƒ_{RS2} is 20, which is twice as great as the modulation frequency ω. The frequency shift of the second reception signal ƒ_{RS2} is 2ω, and ω is greater than ƒₘₐₓ/2. The center frequency of a second beat signal ƒ₂″ generated by mixing the second reception signal ƒ_{RS2} and the transmission signal ƒ_{TS} may be in a relatively highest frequency domain, and accordingly, may be out of the DC noise effect. The center frequency of the second beat signal ƒ₂″ may have a value greater than ƒₘₐₓ. As used herein, ƒₘₐₓ may refer to a minimum value that may render the frequency band of the second beat signal ƒ₂″ greater than the frequency band of the first beat signal ƒ₁. That is, the first beat signal ƒ₁ and the second beat signal ƒ₂″ may be isolated from each other in the frequency domain. As described with reference to FIG. 7, the AD converter 160 may convert the measurement result of at least one photodetector into a digital signal and extract the first beat signal ƒ₁ and the second beat signal ƒ₂ by using a software filter. By the adjustment for the frequency band of the second beat signal to be greater than the frequency band of the first beat signal, the AD converter 160 may separate and extract the first beat signal ƒ₁ and the second beat signal ƒ₂ accurately.

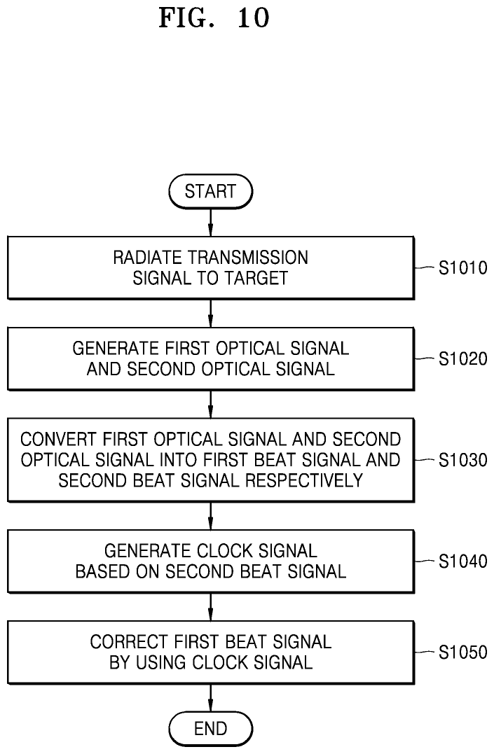

FIG. 10 is a flowchart for illustrating an operating method of the LiDAR device, according to an embodiment. Referring to FIG. 10, the operating method of the LiDAR device, according to an embodiment, may include operations processed by the LiDAR device 1000 described with reference to FIGS. 1 to 9. Accordingly, the description of the LiDAR device 1000 may be applicable to the method of FIG. 10.

In operation S1010, the LiDAR device 1000 may radiate the transmission signal TS to the target 200. The transmitter may radiate the transmission signal TS having a frequency-modulated continuous wave to the target 200.

For example, the transmitter may include the laser 110, the modulator, and the optical antenna 190. The transmitter may generate laser light of a particular wavelength by using the laser 110 and may modulate the transmission signal TS generated by the laser 110 by using the modulator. The transmitter may modulate the frequency of the transmission signal TS to vary according to time and radiate the transmission signal TS through the optical antenna 190 to the target 200 of which distance and/or speed is to be measured.

In operation S1020, by using at least one optical interferometer, the LIDAR device 1000 may generate the first optical signal by mixing the first reception signal RS1 and the transmission signal TS and generate the second optical signal by mixing the second reception signal RS2 and the transmission signal TS.

The LiDAR device 1000 may include the optical element 120 arranged between the transmitter and the target 200 and configured to partially reflect the transmission signal TS. The optical element 120, according to an embodiment, may include a modulator 121 and a reflector 125.

Accordingly, the part of the transmission signal TS which has been radiate towards the target 200 may be reflected from the target 200 after passing through the optical element 120 to form the first reception signal RS1, and the rest of transmission signal TS may be reflected from the optical element 120 to form the second reception signal RS2. The frequency shift caused to the second reception signal RS2 passing through the modulator 121 twice may be twice as great as the modulation frequency ω.

In operation S1030, the LiDAR device 1000 may convert the first optical signal and the second optical signal into electric signals by using the at least one photodetector 130 to generate the first beat signal ƒ₁ and the second beat signal ƒ₂.

The transmission signal TS may cause interference between the first reception signal RS1 and the second reception signal RS2. For example, there may be interference between the transmission signal TS and each of the first reception signal RS1 and the second reception signal RS2. Accordingly, the LiDAR device 1000 may generate the first optical signal and the second optical signal by using one optical interferometer.

The first beat signal ƒ₁ may be generated by the interference between the transmission signal TS and the first reception signal RS1, and the second beat signal ƒ₂ may be generated by the interference between the transmission signal TS and the second reception signal RS2. Accordingly, the LiDAR device 1000 may detect the first beat signal ƒ₁ and the second beat signal ƒ₂ by differentiating between the first optical signal and the second optical signal.

In addition, the LiDAR device 1000 may further include the circulator 180. The circulator 180 may be arranged on an optical path of the LiDAR device and may divide the transmission signal TS from the reception signal RS to avoid mutual interference. For example, when the transmission signal TS has arrived at the target 200 through a path, by using the circulator 180, the first reception signal RS1 and the second reception signal RS2, which may be reflected from the target 200 and/or the optical element 120, may be received through different paths from each other.

In operation S1040, the LiDAR device 1000 may generate the clock signal CS based on the second beat signal ƒ₂. The LiDAR device 1000 may further include the filter 140, the clock signal generator 150, and the AD converter 160.

The LiDAR device 1000 may isolate the first beat signal ƒ₁ and the second beat signal ƒ₂ by frequency band by using the filter 140.

The LiDAR device 1000 may generate the clock signal CS based on the extracted second beat signal ƒ₂ by using the clock signal generator 150.

For example, by using the clock signal generator 150, the LiDAR device 1000 may generate the clock signal CS by thresholding the second beat signal ƒ₂ and multiplying the frequency. The clock signal generator 150 may convert a waveform of the second beat signal ƒ₂ from a sine waveform to a discrete pulse waveform and then generate the clock signal CS by multiplying the second beat frequency.

In an embodiment, the LiDAR device 1000 may generate the clock signal CS through multiplying of the second beat frequency and thresholding by using the clock signal generator 150.

In operation S1050, the LiDAR device 1000 may correct the first beat signal ƒ₁ by using the clock signal CS.

For example, by using the AD converter 160, the LiDAR device 1000 may adjust the sampling timing to avoid a distortion of phase information of the first beat signal ƒ₁ by detecting zero-crossing through matching of the clock signal CS generated by the clock signal generator 150 and the first beat signal ƒ₁. The LiDAR device 1000 may accurately synchronize the clock signal CS and the first beat signal ƒ₁ by detecting an exact sampling timing of the first beat signal ƒ₁, and accordingly, the corrected first beat signal ƒ₁′ may be generated.

In an embodiment, by using the AD converter 160, the LiDAR device 1000 may correct the first beat signal ƒ₁ by reducing or removing a distortion of the measurement result by the at least one photodetector and by using the clock signal CS generated by the clock signal generator 150.

The LiDAR device 1000 may extract the corrected first beat signal ƒ₁′ by using the filter 140 and may identify a speed of the target 200 and/or a distance to the target 200 by using the extracted first beat signal ƒ₁′.

According to the operating method of the LiDAR device 1000 of the present disclosure, by using the optical element 120, the LiDAR device 1000 may receive the first reception signal RS1 reflected from the target 200 and the second reception signal RS2 reflected from the optical element 120. Accordingly, the operating method of the LiDAR device 1000 of the disclosure may improve the performance of the LiDAR device 1000 by correcting the first beat signal ƒ₁ based on the second beat signal ƒ₂ even when the transmission signal TS has a frequency increasing and/or decreasing in a non-linear manner, when compared to a related LiDAR device. The LIDAR device 1000 may monitor potential nonlinearity in the transmission signal TS in real time and may improve linearity by correcting the first beat signal ƒ₁ based on the second beat signal ƒ₂ using the filter 140, the clock signal generator 150, and the AD converter 160.

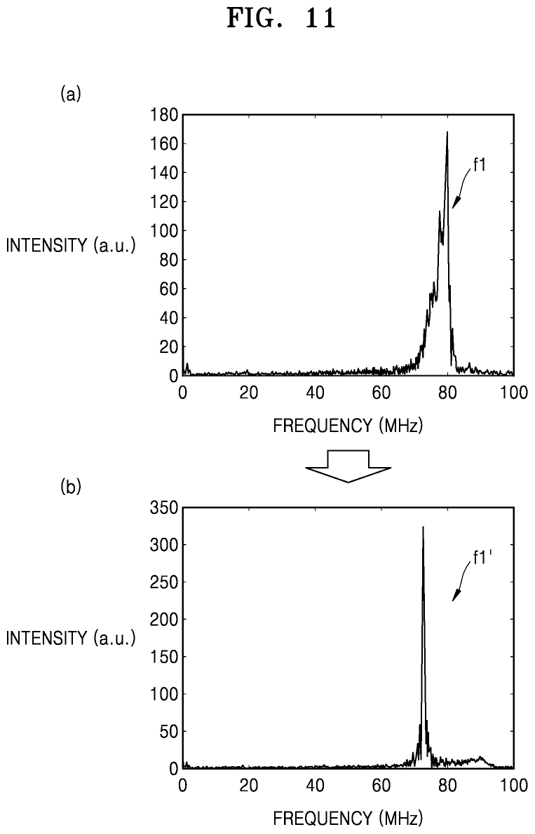

FIG. 11 is depicts graphs showing characteristics of the first beat signal before and after correction, according to an embodiment. Referring to FIG. 11, the graph (a) shows the first beat signal ƒ₁ that may not be corrected, and the graph (b) shows the corrected first beat signal ƒ₁′ that may be corrected.

As shown in FIG. 11, the frequency bandwidth of the first beat signal ƒ₁ of the graph (a) may be wider than the frequency bandwidth of the corrected first beat signal ƒ₁′ of the graph (b). That is, by resampling the first beat signal ƒ₁ based on the second beat signal ƒ₂, the quality factor of the LiDAR device 1000 may increase.

By including the optical element 120, the LiDAR device 1000 of the present disclosure may receive the first reception signal RS1 reflected from the target 200 and the second reception signal RS2 reflected from the optical element 120. Accordingly, the LiDAR device 1000 of the disclosure may improve the performance of the LiDAR device 1000 by correcting the first beat signal ƒ₁ based on the second beat signal ƒ₂, even when the transmission signal TS has a frequency increasing and/or decreasing in a non-linear manner, when compared to a related LiDAR device.

In addition, as the optical element 120 shifts the frequency of the second reception signal RS2, the second beat signal ƒ₂ used in correcting the first beat signal ƒ₁ may be protected against DC noise, and the first beat signal ƒ₁ and the second beat signal ƒ₂ may be isolated in the frequency domain.

FIG. 12 is a conceptual diagram illustrating the LiDAR device, according to an embodiment.

Referring to FIG. 12, the LiDAR device 1000 may include a light source 300, a transceiver 400, and the circuit 500. The light source 300, the transceiver 400, and the circuit 500 may be arranged on one chip (or a semiconductor optical device).

In an embodiment, the light source 300 may generate light L having an operation wavelength (e.g., wavelength of electromagnetic spectrum). The light L may also be referred to as a transmission signal, optical signal, laser beam, light beam, optical beam, emitted light, or beam. In an embodiment, the light source 300 may further include an optical modulator for modulation of light.

For the FMCW driving, the optical modulator (or light source 300) may conduct frequency modulation (or chirping) with respect to the operation wavelength as described with reference to FIG. 1.

In an embodiment, the transceiver 400 may include a focal plane array FPA in which a plurality of pixels PX may be arranged on a focal plane 401 in a matrix and a lens 402 for controlling a light output angle.

The transceiver 400 may be functionally divided into a transmitter and a receiver.

The transmitter may output the light L as a transmission signal from one pixel PX included in the focal plane array FPA.

In an embodiment, the lens 402 may control a light output angle when the light L is emitted from the pixels PX to the free space. For example, the lens 402 may include, but not be limited to, a prism, a micro prism array, a diffraction grating, or the like.

The receiver may mix a transmission signal and an incident reception signal, which may be the transmission signal reflected from the target, and convert the same into electric signals. For example, a 50:50 coupling may be performed by using a second optical coupler 430 described with reference to FIG. 13, and the signal may be incident to a photodiode 441. However, the coupling method is not limited thereto, and the coupling may be performed by using, for example, a beam splitter. Regardless of a specific method for mixing, signals obtained from the receiver may include beating frequency information of light. Light includes information about distance and/or speed of the target, which may be reflected on the beating frequency.

The circuit 500 may be connected to the light source 300 and the transceiver 400 and may control operations thereof. For example, before converting a beating signal BS into a digital signal, the circuit 500 may convert a distance and/or speed of the target to analyze the frequency in an analog state. The circuit 500 may further include at least some of the filter 140, the clock signal generator 150, and the AD converter 160 described with reference to FIGS. 4 to 7.

FIG. 13 is a diagram illustrating a pixel included in the focal plane array, according to an embodiment.

Referring to FIG. 13, the pixels PX may divide an input signal IS (or the light L) into a local oscillator signal LO and a transmission signal TS, couple the transmission signal TS to the free space, couple the reception signal RS to the pixels PX again, and mix the local oscillator signal LO with the reception signal RS.

The pixels PX, according to an embodiment, may include a first optical coupler 410, an optical antenna 420, the second optical coupler 430, and a photoelectric converter 440. The pixels PX may receive light (e.g., the light L) as the input signal IS. The first optical coupler 410 may be arranged between an input terminal INT and the optical antenna 420. The first optical coupler 410 may divide the input signal IS received from the input terminal into the local oscillator signal LO and the transmission signal TS. The optical antenna 420 may receive the reception signal RS reflected from the target.

The optical antenna 420 may be and/or may include a device configured to emit light from an on-chip wave guide to the free space and/or combine light from the free space to the on-chip wave guide. The optical antenna 420 may be implemented by a grating coupler, an edge coupler, an integrated reflector, or a spot size converter. However, embodiments of the present disclosure are not limited thereto. The optical antenna 420 may provide the reception signal RS to the second optical coupler 430.

The second optical coupler 430 may generate an output signal OS by mixing the reception signal RS with the local oscillator signal LO divided and provided by the first optical coupler 410.

The pixels PX may include the photoelectric converter 440 configured to convert the output signal OS, which may be an optical signal, into an electric signal. The photoelectric converter 440 may include the balanced photodiode 441 configured to convert an optical signal into an electric signal beating frequency detection and a transimpedance amplifier (TIA) 442 configured to amplify the intensity of the electric signal generated by the photodiode 441. For example, the transimpedance amplifier 442 may amplify a current generated by the balanced photodiode 441 and convert the same into a voltage. The electric signal provided from the transimpedance amplifier 442 may be provided to the circuit (e.g., circuit 500 of FIG. 12).

The pixels PX, according to an embodiment, may further include an optical amplifier 450 arranged between the first optical coupler 410 and the optical antenna 420 and may be configured to compensate for optical loss. For example, the optical amplifier 450 may be a semiconductor optical amplifier (SOA) and may amplify an optical signal such that the intensity of light generated by the light source (e.g., light source 300 of FIG. 12) is maintained at the optical antenna 420. Alternatively, the optical amplifier 450 may increase a signal-to-noise ratio (SNR).

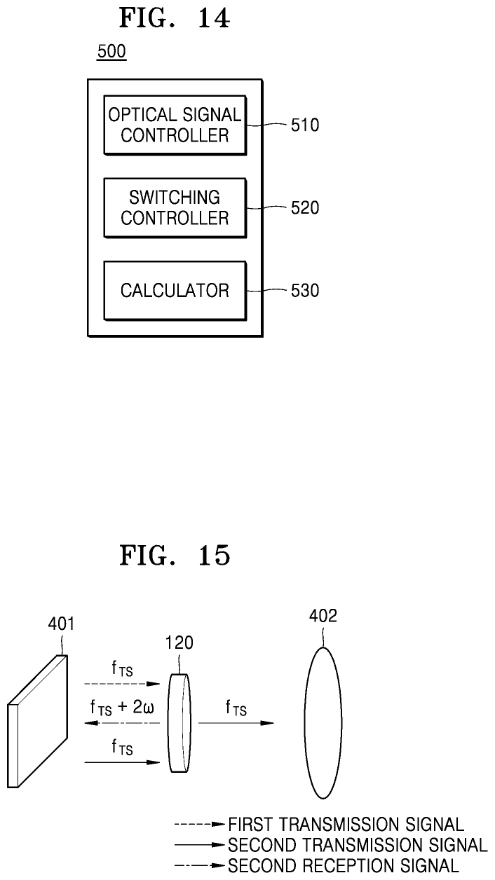

FIG. 14 is a block diagram illustrating a circuit, according to an embodiment.

Referring to FIG. 14, the circuit 500 may include an optical signal controller 510, a switching controller 520, and a calculator 530.

The optical signal controller 510 may control frequency modulation (or chirping) of the light source 300 and may include a feedback circuit such as, but not limited to, a phase-locked loop (PPL).

The switching controller 520 may control switching of the focal plane array FPA of at least one axis included in the transmitter of the transceiver 400. The switching control may be performed through operation of an optical micro-electromechanical system (MEMS). In addition, the control may be and/or may include a heating control with respect to a thermo-optical element configured to operate a phase, such as, but not limited to, a micro ring resonator, a Mach-Zehnder interferometer, or the like. The control may be and/or may include control for electro-optical modulation according to adjustment of carrier concentration.

The calculator 530 may calculate at least one of a distance or a speed of the target based on the first beat signal ƒ₁. The calculator 530 may increase the SNR of the LiDAR device by calculating at least one of the distance or the speed of the target based on the corrected first beat signal ƒ₁′.

FIGS. 15 to 17 depict diagrams illustrating examples of arrangement relations of the optical element, according to an embodiment.

Referring to FIG. 15, the optical element 120 may be arranged between the focal plane 401 and the lens 402. The transceiver (e.g., the transceiver 400 of FIG. 12) may be arranged as a plurality of pixels on the focal plane 401. The lens 402 may control a light output angle of light emitted from the plurality of pixels to the free space.

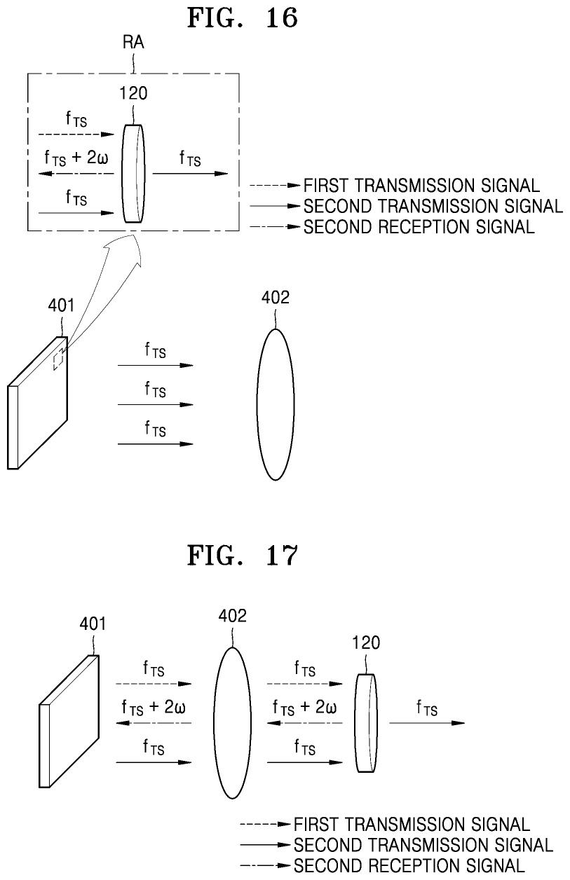

Referring to FIG. 16, the optical element 120 may be arranged in an area RA of the focal plane 401. The transceiver (e.g., the transceiver 400 of FIG. 12) may be arranged as a plurality of pixels on the focal plane 401. The area RA in which the optical element 120 is arranged may overlap the focal plane 401. The lens 402 may control a light output angle of light emitted from the plurality of pixels to the free space. As shown in FIG. 16, as the optical element 120 is arranged in the area RA of the focal plane 401, the LiDAR device 1000 may be miniaturized.

Referring to FIG. 17, the optical element 120 may be arranged outside the lens 402. That is, the lens 402 may be arranged between the focal plane and the optical element 120.

As described above, the LiDAR, device according to an embodiment, may include a transmitter configured to radiate a transmission signal to a target, an optical element arranged between the transmitter and the target and configured to modulate a part of the transmission signal into a modulation frequency and reflect the same, a receiver configured to generate a first beat signal by mixing a first reception signal reflected from the target with the transmission signal and generate a second beat signal by mixing a second reception signal reflected from the optical element with the transmission signal, and a circuit connected to the transmitter and the receiver and configured to generate a clock signal based on the second beat signal and correct the first beat signal by using the clock signal.

The optical element may include a modulator configured to modulate a first transmission signal which is a part of the transmission signal passing the optical element into the modulation frequency to pass the first transmission signal at a modulated frequency and pass at a same frequency a second transmission signal, which is the rest of the transmission signal, and a reflector configured to reflect the first transmission signal having the modulated frequency to the modulator.

The frequency shift caused to the second reception signal reflected from the optical element may be twice as great as the modulation frequency.

The modulator may be an acousto-optical modulator (AOM).

The transmitter and the receiver may be arranged as a plurality of pixels on a focal plane, the LiDAR device may further include a lens controlling a light output angle of light emitted from the plurality of pixels to a free space, and the optical element may be arranged between the focal plane and the lens.

The transmitter and the receiver may be arranged as a plurality of pixels on a focal plane, and the optical element may be arranged in an area of the focal plane.

The transmitter and the receiver may be arranged as a plurality of pixels on a focal plane, the LiDAR device may further include a lens controlling a light output angle of light emitted from the plurality of pixels to a free space, and the lens may be arranged between the focal plane and the optical element.

The circuit may extract the second beat signal from a measurement result of at least one photodetector by using a filter and generate the clock signal based on the extracted second beat signal.

The circuit may convert a measurement result of at least one photodetector into a digital signal, extract the first beat signal and the second beat signal from the converted digital signal by using a software filter, and correct the first beat signal based on the extracted second beat signal.

The circuit may calculate at least one of a speed of the target and a distance to the target based on the corrected first beat signal.

A frequency of the transmission signal may be modulated according to time.

The operating method of the LiDAR device according to an embodiment includes irradiating a transmission signal to a target by using a transmitter, generating a first beat signal by mixing a first reception signal reflected from the target with the transmission signal and generating a second beat signal by mixing a second reception signal reflected from an optical element with the transmission signal, generating a clock signal based on the second beat signal, and correcting the first beat signal by using the clock signal, wherein the optical element may be arranged between the transmitter and the target and may be configured to modulate a part of the transmission signal into a modulation frequency and reflect the same.

The generating of the second beat signal may include by using the optical element, passing at a modulated frequency a first transmission signal, which is a part of the transmission signal passing the optical element, by modulating the first transmission signal into the modulation frequency and passing at a same frequency a second transmission signal, which is the rest of the transmission signal, and by using the optical element, reflecting the first transmission signal having the modulated frequency to the modulator.

The generating of the clock signal based on the second beat signal may include extracting the second beat signal from a measurement result of the at least one photodetector by using a filter, and generating the clock signal based on the extracted second beat signal.

The generating of the clock signal based on the extracted second beat signal may include generating the clock signal by thresholding the extracted second beat signal and then multiplying a frequency of the extracted second beat signal.

The generating of the clock signal based on the extracted second beat signal may include generating the clock signal by multiplying a frequency of the extracted second beat signal and then thresholding the extracted second beat signal.

The correcting of the first beat signal by using the clock signal may include correcting the first beat signal by removing a distortion in a measurement result of at least one photodetector by using the clock signal.

The correcting of the first beat signal by using the clock signal may include extracting the first beat signal from a measurement result of the at least one photodetector by using a filter, and correcting the first beat signal by removing a distortion in the extracted first beat signal by using the clock signal.

The operating method may further include calculating at least one of a speed of the target and a distance to the target based on the corrected first beat signal.

The LiDAR device and the operating method of the LiDAR device may be applied to various electronic devices configured to detect a distance to a target (e.g., an external object) and obtain a three-dimensional (3D) image.

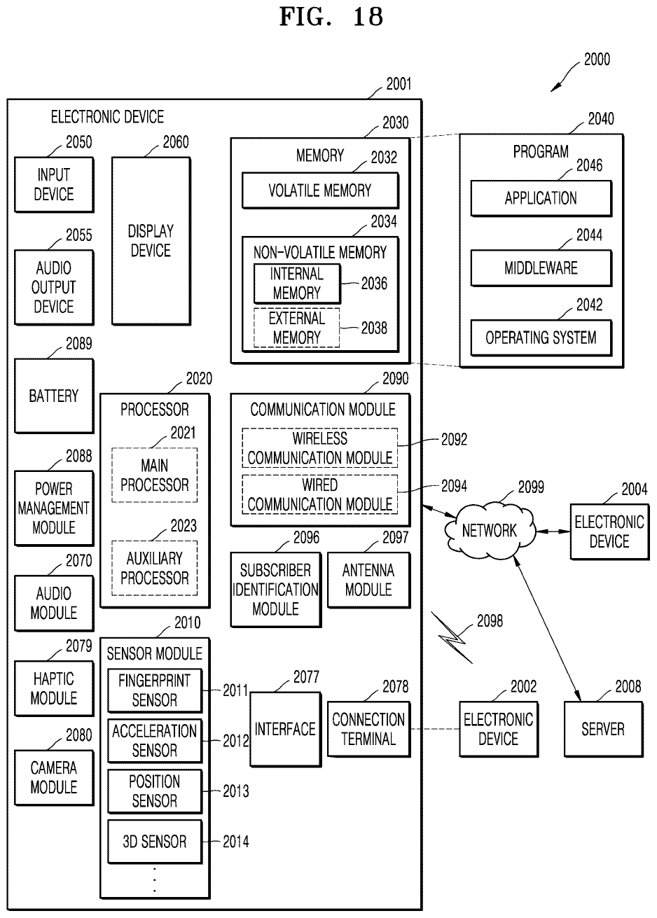

FIG. 18 is a block diagram illustrating a schematic configuration of an electronic device including a LIDAR device, according to an embodiment.

Referring to FIG. 18, in a network environment 2000, an electronic device 2001 may communicate with another electronic device 2002 through a first network 2098 (e.g., a short-range wireless communication network or the like), and/or may communicate with another electronic device 2004 and/or a server 2008 through a second network 2099 (e.g., a long-range wireless communication network or the like). The electronic device 2001 may communicate with the electronic device 2004 through the server 2008. The electronic device 2001 may include a processor 2020, a memory 2030, an input device 2050, an audio output device 2055, a display device 2060, an audio module 2070, a sensor module 2010, an interface 2077, a haptic module 2079, a camera module 2080, a power management module 2088, a battery 2089, a communication module 2090, a subscriber identification module 2096, and/or an antenna module 2097. In the electronic device 2001, at least one (e.g., the display device 2060 or the like) of constituent elements may be omitted and/or other constituent elements may be added. Some of the foregoing components may be implemented as a single integrated circuit. For example, a fingerprint sensor 2011 of the sensor module 2010, or an iris sensor, an illumination sensor, or the like may be implemented by being embedded in the display device 2060 (e.g., a display or the like)

The processor 2020 may control one or a plurality of other constituent elements (e.g., hardware and software constituent elements or the like) of the electronic device 2001 connected to the processor 2020 by executing software (e.g., a program 2040 or the like), and perform various data processing or calculations. As a part of the data processing or calculations, the processor 2020 may load, in a volatile memory 2032, commands and/or data received from other constituent elements (e.g., the sensor module 2010, the communication module 2090, or the like), process the command and/or data stored in the volatile memory 2032, and store result data in a non-volatile memory 2034. The processor 2020 may include a main processor 2021 (e.g., a central processing unit, an application processor, or the like) and an auxiliary processor 2023 (e.g., a graphics processing unit, an image signal processor, a sensor hub processor, a communication processor, or the like) that may be operable independently of and/or together with the main processor 2021. In an embodiment, auxiliary processor 2023 may use less power than the main processor 2021 and may perform a specialized function.

Instead of the main processor 2021 when the main processor 2021 is in an inactive state (e.g., a sleep state), or with the main processor 2021 when the main processor 2021 is in an active state (e.g., an application execution state), the auxiliary processor 2023 may control functions and/or states related to some constituent elements (e.g., the display device 2060, the sensor module 2010, the communication module 2090, or the like) of the constituent elements of the electronic device 2001. The auxiliary processor 2023 (e.g., an image signal processor, a communication processor, or the like) may be implemented as a part of functionally related other constituent elements (e.g., the camera module 2080, the communication module 2090, or the like)

The memory 2030 may store various data that may be needed by the constituent elements (e.g., the processor 2020, the sensor module 2010, or the like) of the electronic device 2001. The data may include, for example, software (e.g., the program 2040 or the like), input data, and/or output data about commands related thereto. The memory 2030 may include the volatile memory 2032 and/or the non-volatile memory 2034.

The program 2040 may be stored in the memory 2030 as software, and may include an operating system 2042, middleware 2044, and/or an application 2046.

The input device 2050 may receive commands and/or data to be used for constituent elements (e.g., the processor 2020 or the like) of the electronic device 2001, from the outside (e.g., a user or the like) of the electronic device 2001. The input device 2050 may include, but not be limited to, a microphone, a mouse, a keyboard, and/or a digital pen (e.g., a stylus pen or the like).

The audio output device 2055 may output an audio signal to the outside of the electronic device 2001. The audio output device 2055 may include a speaker and/or a receiver. The speaker may be used for general purposes such as, but not limited to, multimedia play or playback, and the receiver may be used to receive incoming calls. The receiver may be integrated as a part of the speaker and/or implemented independently as a separate device.

The display device 2060 may visually provide information to the outside of the electronic device 2001. The display device 2060 may include a display, a hologram device, or a projector, and a control circuit to control a device. The display device 2060 may include touch circuitry set to detect a touch and/or a sensor circuit (e.g., a pressure sensor or the like) and/or to measure the strength of a force generated by the touch.

The audio module 2070 may convert sound into electric signals and/or reversely electric signals into sound. The audio module 2070 may obtain sound through the input device 2050, and/or output sound through a speaker and/or a headphone of another electronic device (e.g., the electronic device 2002 or the like) connected to the audio output device 2055 and/or the electronic device 2001 in a wired or wireless manner.

The sensor module 2010 may detect an operation state (e.g., power, temperature, or the like) of the electronic device 2001, or an external environment state (e.g., a user state or the like), and generate an electrical signal and/or a data value corresponding to a detected state. The sensor module 2010 may include a fingerprint sensor 2011, an acceleration sensor 2012, a position sensor 2013, a 3D sensor 2014, or the like, and may further include, but not be limited to, an iris sensor, a gyro sensor, an atmospheric pressure sensor, a magnetic sensor, a grip sensor, a proximity sensor, a color sensor, an infrared (IR) sensor, a biometric sensor, a temperature sensor, a humidity sensor, an illumination sensor, or the like.

The 3D sensor 2014 may be configured to radiate a predetermined light to a target and to analyze light reflected from the target to sense its shape, movement, or the like and may include the LiDAR device 1000 according to the aforementioned embodiments.

The interface 2077 may support one or more specified protocols used for the electronic device 2001 to be connected to another electronic device (e.g., the electronic device 2002 or the like) in a wired or wireless manner. The interface 2077 may include a high-definition multimedia interface (HDMI), a universal serial bus (USB) interface, a secure digital (SD) card interface, and/or an audio interface.

A connection terminal 2078 may include a connector for the electronic device 2001 to be physically connected to another electronic device (e.g., the electronic device 2002 or the like). The connection terminal 2078 may include an HDMI connector, a USB connector, an SD card connector, and/or an audio connector (e.g., a headphone connector or the like).

The haptic module 2079 may convert electric signals into mechanical stimuli (e.g., vibrations, movements, or the like) or electric stimuli that may be perceivable by a user through tactile or motor sensations. The haptic module 2079 may include, but not be limited to, a motor, a piezoelectric device, and/or an electric stimulation device.

The camera module 2080 may capture a still image and/or film a video (e.g., a sequence of still images). The camera module 2080 may include a lens assembly including one or more lenses, image sensors, image signal processors, and/or flashes. The lens assembly included in the camera module 2080 may collect light emitted from a target object for imaging.

The power management module 2088 may manage power supplied to the electronic device 2001. The power management module 2088 may be implemented as a part of a power management integrated circuit (PMIC).

The battery 2089 may supply power to the constituent elements of the electronic device 2001. The battery 2089 may include non-rechargeable primary cells, rechargeable secondary cells, and/or fuel cells.

The communication module 2090 may establish a wired communication channel and/or a wireless communication channel between the electronic device 2001 and another electronic device (e.g., the electronic device 2002, the electronic device 2004, the server 2008, or the like), and support a communication through an established communication channel. The communication module 2090 may be operated independent of the processor 2020 (e.g., the application processor or the like), and may include one or more communication processors supporting a wired communication and/or a wireless communication. The communication module 2090 may include a wireless communication module 2092 (e.g., a cellular communication module, a short-range wireless communication module, a global navigation satellite system (GNSS) communication module, or the like), and/or a wired communication module 2094 (e.g., a local area network (LAN) communication module, a power line communication module, or the like). Among the above communication modules, a corresponding communication module may communicate with another electronic device through the first network 2098 (e.g., a short-range communication network such as, but not limited to, Bluetooth™, Wireless-Fidelity (Wi-Fi) Direct, or infrared data association (IrDA)) or the second network 2099 (e.g., a long-range communication network such as a, but not limited to, a cellular network, the Internet, a computer network (e.g., a LAN, a wide-area network (WAN), or the like)). Such various types of communication modules may be integrated into one component (e.g., a single chip or the like), or may be implemented as a plurality of separate components (e.g., multiple chips). The wireless communication module 2092 may verify and authenticate the electronic device 2001 in a communication network such as the first network 2098 and/or the second network 2099 by using subscriber information (e.g., an international mobile subscriber identifier (IMSI) or the like) stored in the subscriber identification module 2096.

The antenna module 2097 may transmit signals and/or power to the outside (e.g., another electronic device or the like) or receive signals and/or power from the outside. The antenna may include a radiator consisting of conductive patterns formed on a substrate (e.g., a printed circuit board (PCB) or the like). The antenna module 2097 may include one or a plurality of antennas. When the antenna module 2097 includes a plurality of antennas, the communication module 2090 may select, from among the antennas, an appropriate antenna for a communication method used in a communication network, such as the first network 2098 and/or the second network 2099. Signals and/or power may be transmitted and/or received between the communication module 2090 and another electronic device through the selected antenna. Other parts (e.g., a radio frequency integrated circuit (RFIC) or the like) than the antenna may be included as a part of the antenna module 2097.

Some of the components may be connected and exchange signals (e.g., commands, data, or the like) with each other through communication methods among peripheral devices (e.g., a bus, general purpose input and output (GPIO), serial peripheral interphase (SPI), mobile industry processor interface (MIPI), or the like).

The command or data may be transmitted and/or received between the electronic device 2001 and the external electronic device 2004 through the server 2008 connected to the second network 2099. The electronic devices 2002 and 2004 may be of a type that may the same as or different from the electronic device 2001. All or a part of operations executed in the electronic device 2001 may be executed in one or more electronic devices (e.g., the other electronic device 2002, the external electronic device 2004, and the server 2008). For example, when the electronic device 2001 needs to perform a function or service, the electronic device 2001 may request one or more electronic devices to perform part of the whole of the function or service, instead of performing the function or service. The one or more electronic devices receiving the request may perform additional function or service related to the request, and transmit a result of the performance to the electronic devices 2001. To this end, cloud computing, distributed computing, and/or client-server computing technologies may be used.

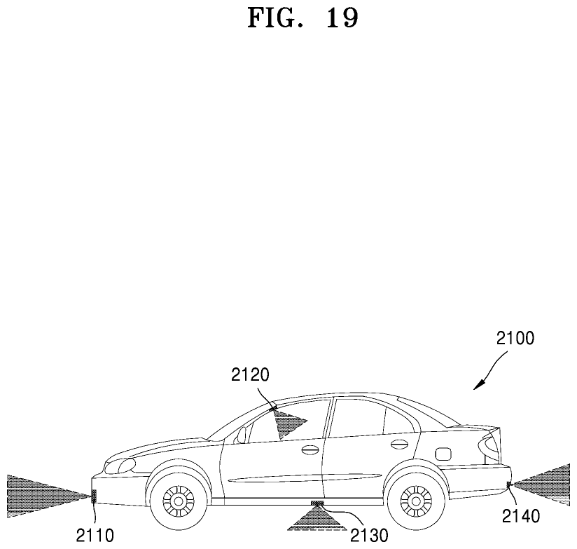

FIG. 19 is a diagram illustrating an example in which a LIDAR device is applied to a vehicle, according to an embodiment.

Referring to FIG. 19, a vehicle 2100 may include a plurality of LiDAR devices (e.g., a first LiDAR device 2110, a second LiDAR device 2120, a third LiDAR device 2130, and a fourth 2140 LiDAR device) arranged at various positions of the vehicle 2100. The vehicle 2100 may provide a driver with various pieces of information about the periphery of the vehicle 2100, by using the plurality of first to fourth LiDAR devices 2110 to 2140, and thus, for example, an object or a person near the vehicle 2100 may be automatically recognized and information needed for autonomous driving is provided. Each of the plurality of first to fourth LiDAR devices 2110 to 2140 may be the LiDAR device 1000, according to the embodiments described above.

It is to be understood that embodiments described herein are to be considered in a descriptive sense only and not for purposes of limitation. Descriptions of features or aspects within each embodiment may typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A light detection and ranging (LiDAR) device, comprising:
a transmitter configured to radiate a transmission signal to a target, the transmission signal comprising a first transmission signal portion and a second transmission signal portion different from the first transmission signal portion;
an optical element between the transmitter and the target and configured to:
modulate the first transmission signal portion with a modulation frequency, and
reflect the modulated first transmission signal portion;
a receiver configured to:
generate a first beat signal by mixing a first reception signal reflected from the target with the transmission signal, and
generate a second beat signal by mixing a second reception signal reflected from the optical element with the transmission signal; and
a circuit coupled with the transmitter and the receiver and configured to:
generate a clock signal based on the second beat signal, and
correct the first beat signal by using the clock signal.

2. The LiDAR device of claim 1, wherein the optical element comprises:
a modulator configured to:
modulate the first transmission signal portion with the modulation frequency,
pass the modulated first transmission signal portion, and
pass the second transmission signal portion without modulation; and
a reflector configured to reflect the modulated first transmission signal portion to the modulator.

3. The LiDAR device of claim 2, wherein the modulator is further configured to:
modulate the modulated first transmission signal portion reflected from the reflector resulting in the second reception signal, and
wherein a frequency shift of the second reception signal is equal to two times the modulation frequency.

4. The LiDAR device of claim 2, wherein the modulator comprises an acousto-optical modulator (AOM).

5. The LiDAR device of claim 1, wherein the transmitter and the receiver are disposed as a plurality of pixels on a focal plane,
wherein the LiDAR device further comprises a lens configured to control a light output angle of light emitted from the plurality of pixels to a free space, and
wherein the optical element is between the focal plane and the lens.

6. The LiDAR device of claim 1, wherein the transmitter and the receiver are disposed as a plurality of pixels on a focal plane, and
wherein the optical element is disposed in an area of the focal plane.

7. The LiDAR device of claim 1, wherein the transmitter and the receiver are disposed as a plurality of pixels on a focal plane,
wherein the LiDAR device further comprises a lens configured to control a light output angle of light emitted from the plurality of pixels to a free space, and
wherein the lens is between the focal plane and the optical element.

8. The LiDAR device of claim 1, wherein the circuit is further configured to:
extract, by using a filter, the second beat signal from a measurement result of at least one photodetector, and
generate the clock signal based on the extracted second beat signal.

9. The LiDAR device of claim 1, wherein the circuit is further configured to:
convert a measurement result of at least one photodetector into a digital signal,
extract, by using a software-based filter, the first beat signal and the second beat signal from the digital signal, and
correct the first beat signal based on the extracted second beat signal.

10. The LiDAR device of claim 1, wherein the circuit is further configured to:
calculate, based on the corrected first beat signal, at least one of a speed of the target or a distance to the target.

11. The LiDAR device of claim 1, wherein the optical element is further configured to:
modulate a frequency of the first transmission signal portion based on time.

12. An operating method of a light detection and ranging (LiDAR) device, the operating method comprising:
irradiating, by using a transmitter of the LiDAR device, a transmission signal to a target, the transmission signal comprising a first transmission signal portion and a second transmission signal portion different from the first transmission signal portion;
generating a first beat signal by mixing a first reception signal reflected from the target with the transmission signal;
modulating, by using an optical element of the LiDAR device, the first transmission signal portion with a modulation frequency, resulting in a second reception signal;
generating a second beat signal by mixing the second reception signal with the transmission signal;
generating a clock signal based on the second beat signal; and
correcting the first beat signal by using the clock signal,
wherein the optical element is between the transmitter and the target.

13. The operating method of claim 12, wherein the generating of the second beat signal comprises:
passing, by using the optical element, at a modulated frequency the first transmission signal portion by modulating, by using a modulator of the optical element, the first transmission signal portion with the modulation frequency;
passing, by using the optical element, the second transmission signal portion without modulation; and
reflecting, by using a reflector of the optical element, the modulated first transmission signal portion to the modulator.

14. The operating method of claim 13, further comprising:
modulating the modulated first transmission signal portion reflected from the reflector resulting in the second reception signal,
wherein a frequency shift of the second reception signal is equal to two times the modulation frequency.

15. The operating method of claim 12, wherein the generating of the clock signal comprises:
extracting, by using a filter, the second beat signal from a measurement result of at least one photodetector; and
generating the clock signal based on the extracted second beat signal.

16. The operating method of claim 15, wherein the generating of the clock signal comprises:
generating the clock signal by thresholding the extracted second beat signal and then multiplying a frequency of the thresholded second beat signal.

17. The operating method of claim 13, wherein the generating of the clock signal comprises:
generating the clock signal by multiplying a frequency of the extracted second beat signal and then thresholding the frequency-multiplied second beat signal.

18. The operating method of claim 12, wherein the correcting of the first beat signal comprises:
removing, by using the clock signal, at least one distortion in a measurement result of at least one photodetector.

19. The operating method of claim 12, wherein the correcting of the first beat signal comprises:
extracting, by using a filter, the first beat signal from a measurement result of at least one photodetector; and
correcting, by using the clock signal, the first beat signal by removing a distortion in the extracted first beat signal.

20. The operating method of claim 12, further comprising:
calculating, based on the corrected first beat signal, at least one of a speed of the target or a distance to the target.
